(19) United States
(12) Patent Application Publication
(10) Pub. No.: US 2003/0029839 A1
(43) Pub. Date: Feb. 13, 2003

(54) Method of reducing wet etch rate of silicon nitride

(75) Inventor: Pao-Hwa Chou, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: Winbond Electronics Corp.

(21) Appl. No.: 10/002,502

(22) Filed: Nov. 1, 2001

(30) Foreign Application Priority Data
Aug. 8, 2001 (TW) 90119371

(51) Int. Cl. C23F 1/00; B44C 1/22; C03C 15/00; C03C 25/68

(52) U.S. Cl. 216/87

(57) ABSTRACT

A method of reducing the wet etch rate of silicon nitride relative to that of silicon oxide is disclosed. The method comprises implanting nitrogen-containing ions into silicon nitride films, followed by thermal annealing to repair the implant damage and concurrently promote Si—N bonding in the nitrogen-implanted films. The silicon nitride films thus treated are more resistant to oxide etchants such as HF. The present invention is particularly useful in reducing the wet etch rate of the silicon nitride formed by reacting hexachlorodisilane (Si₂Cl₆) with ammonia (NH₃) at below 650° C.

### BACKGROUND OF THE INVENTION

1. Field of the Invention

The present invention relates generally to semiconductor manufacturing, and more particularly to a method of reducing the wet etch rate of silicon nitride.

2. Description of the Related Arts

Silicon nitride (SiN) is commonly used as insulating layers or as hard masks for silicon oxide (such as in a self-alignment contact process). In general, silicon nitrides are formed by using low pressure chemical vapor deposition (LPCVD) or plasma-enhanced chemical vapor deposition (PECVD) processes. LPCVD silicon nitride and PECVD silicon nitride have substantially the same dry etch rates, but the wet etch rate of PECVD silicon nitride is about ten times faster than that of LPCVD silicon nitride.

Traditional LPCVD silicon nitrides are deposited by reacting dichlorosilane (SiCl₂H₂) with ammonia (NH₃) at temperatures ranging from about 700° C. to 800° C. (hereafter referred to as “DCS-based SiN”). A novel method using hexachlorodisilane (Si₂Cl₆) as silicon source has been proposed to lower the deposition temperature to below 650° C. (hereafter referred to as “HCD-based SiN”). Such low-temperature depositions are very valuable in reducing thermal budget in DRAM (Dynamic Random Access Memory) manufacturing. Unfortunately, the HCD-based SiN shows poor resistance to the etchants used for wet etching silicon oxide, which considerably limits its applications. The HCD-based SiN presents no etch selectivity with respect to thermal oxide when both are exposed to 0.25% HF solution. In the absence of etching selectivity, it is impossible for HCD-based SiN to serve as an etch stop for silicon oxide.

A cylindrical capacitor with MIM (metal-insulator-metal) structure is a promising candidate for next generation DRAMs when the design rule comes to 110 nm or below. In making such a capacitor, silicon nitride is commonly used as an etch stop for silicon oxide and also as a diffusion barrier layer for metal. Referring to FIG. 1A, a cross-section of a partially completed cylindrical capacitor is shown. A cylindrical bottom electrode 19 is formed within an opening through dielectric layers 18, 16, 14, 20, in which layers 18, 14 are silicon oxide, and layers 16 ,12 are silicon nitride. In order to reveal the cylindrical bottom electrode 19, as illustrated in FIG. 1B, the uppermost oxide layer 18 is to be stripped by wet etching using the nitride layer 16 as an etch stop. Although the traditional DCS-based SiN deposited at 700-800° C. is feasible for an etch stop, such high deposition temperatures make it undesirable for use in this process. Because in the stack DRAM fabrication, a capacitor is fabricated after transistors have been formed, the high-temperature deposition will considerably increase the contact resistance of diffusion regions, and thereby adversely affect the transistor performance. Accordingly, it is advantageous if HCD-based SiN, deposited at a much lower temperature can be employed in this process. Before this, the problem of its undesirably high etch rate must be solved first.

U.S. Pat. No. 5,385,630 discloses a process for increasing oxide etch rate by N₂ implantation. In the specific embodiment, N₂ implantation increases the etch rate of the sacrificial oxide relative to that of the field oxide so as to reduce field oxide loss.

In contrast with the above prior art's use of ion implantation to increase the oxide etch rate, the present invention combines ion implantation and thermal annealing to decrease the nitride etch rate.

### SUMMARY OF THE INVENTION

It is therefore an object of the invention to solve the above-mentioned problems and provide a method of reducing the etch rate of silicon nitride relative to that of silicon oxide.

The above and other objects are achieved by implanting nitrogen-containing ions into silicon nitride films, followed by thermal annealing to repair the implant damage and concurrently promote Si—N bonding in the nitrogen-implanted films. The silicon nitride films thus treated are more resistant to oxide etchants such as HF. By this method, the HCD-based SiN can serve as an etch stop for silicon oxide, and therefore it be advantageously employed in a variety of semiconductor fabrications to favor the reduction in thermal budget.

### BRIEF DESCRIPTION OF THE DRAWINGS

The above and other objects, features, and advantages of the present invention will become apparent from the following detailed description of preferred embodiments of the invention explained with reference to the accompanying drawings, in which:

FIGS. 1A to 1B are cross-sections illustrating the step of fabricating a cylindrical capacitor that requires a silicon nitride layer as an etch stop;

FIGS. 2A to 2C are cross-sections illustrating the steps for reducing the wet etch rate of silicon nitride according to a preferred embodiment of the invention;

FIG. 3 is a graph showing effects of different processing conditions (1)-(5) on the hydrogen concentrations of Si—H and N—H bonds and the corresponding S—N peak areas in a SiN film, (1) as deposited; (2) annealed at 950° C. for 20 seconds; (3) 5×10¹⁴ cm⁻² N₂⁺ implanted at 3 keV and then annealed at 950° C. for 20 seconds; (4) 10¹⁵ cm⁻² N₂⁺ implanted at 3 keV and then annealed at 950° C. for 20 seconds; (5) 5×10¹⁵ cm⁻² N₂⁺ implanted at 3 keV and then annealed at 950° C. for 20 seconds; and

FIG. 4 is a graph showing the etch-rate ratio of SiN/SiO₂ versus etching depth of a SiN film.

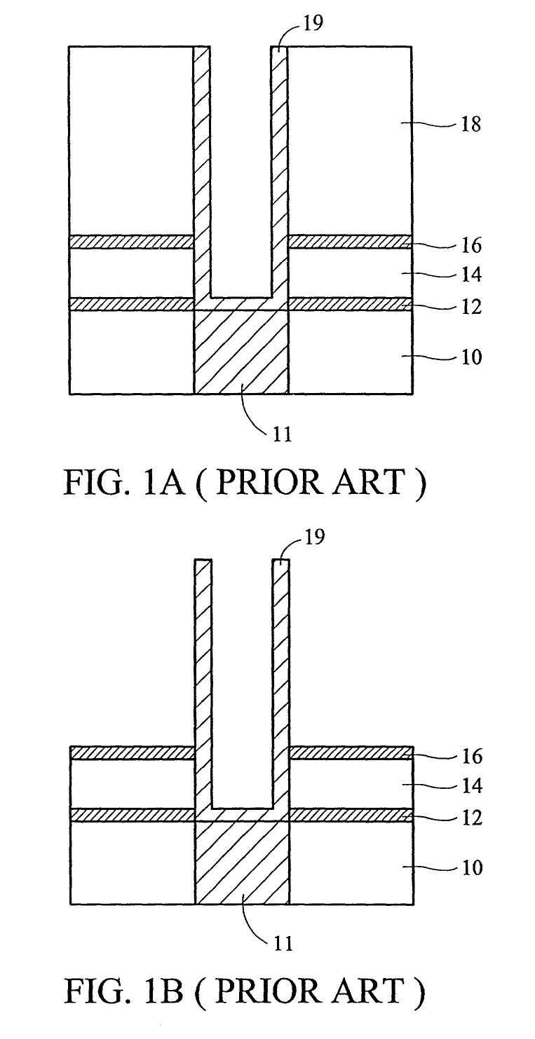

### REFERENCE NUMERALS IN THE DRAWINGS

10 silicon oxide layer

11 conductive plug

12 silicon nitride layer

14 silicon oxide layer

16 silicon nitride layer

18 silicon oxide layer

19 metal layer

100 semiconductor substrate

102 silicon nitride layer

102a N-enriched SiN layer

104 ion implantation

106 thermal annealing step

108 silicon oxide layer

### DESCRIPTION OF THE PREFERRED EMBODIMENTS

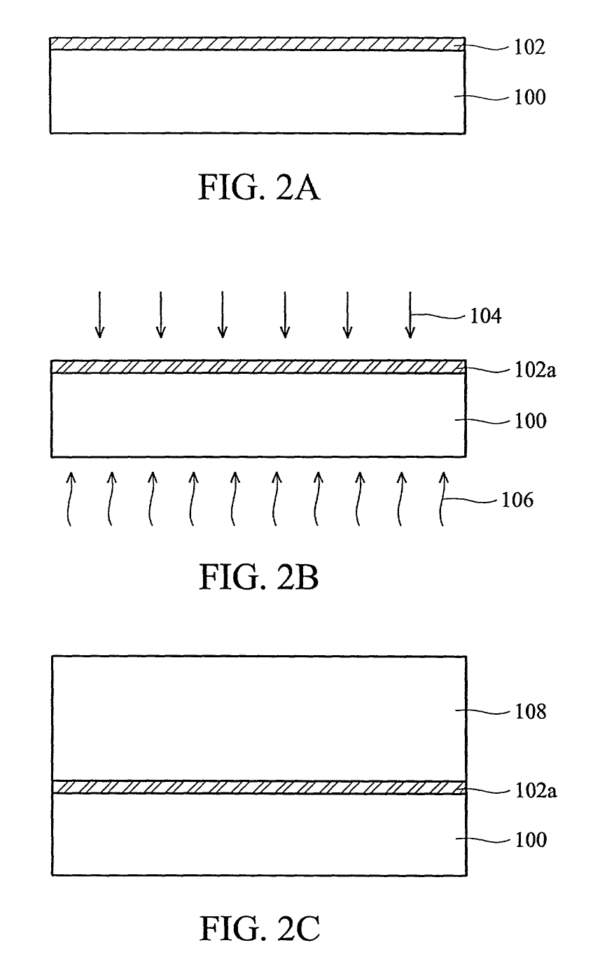

As shown in FIG. 2A, the method of the present invention begins by providing an etch stop coating of silicon nitride 102 over a semiconductor substrate 100. Those skilled in the art will appreciate that semiconductor substrate 100 is understood to possibly include a large number of electrically coupled device components such as MOS transistors, resistors, logic devices, and the like, although this aspect is not shown in FIGS. 2A-2C. The silicon nitride layer that serves as an etch stop typically has a thickness between about 30 and 60 nm. In an exemplary embodiment, the silicon nitride 102 is a LPCVD silicon nitride deposited by reacting hexachlorodisilane (Si₂Cl₆) with ammonia (NH₃) at a temperature below 650° C.

Referring to FIG. 2B, nitrogen-containing ions such as N₂⁺ are implanted, as represented by arrows 104, into the silicon nitride layer 102 to form a nitrogen-enriched layer 102a. The implant dosage and energy of the nitrogen-containing ions can vary depending on the thickness of the silicon nitride layer 102. In general, the dosage can range between 10¹² and 10¹⁷ ions per cm² and the energy can range between 0.5 and 20 keV. For a silicon nitride layer of 30-60 nm in thickness, the nitrogen-containing ions are preferably implanted in a dose of about 10¹³ to 10¹⁵ at an energy of about 1 to 5 keV. The ion implantation also causes implant damage to the silicon nitride layer, including, for example, dissociation of Si—H and N—H bonds and formation of Si dangling bond.

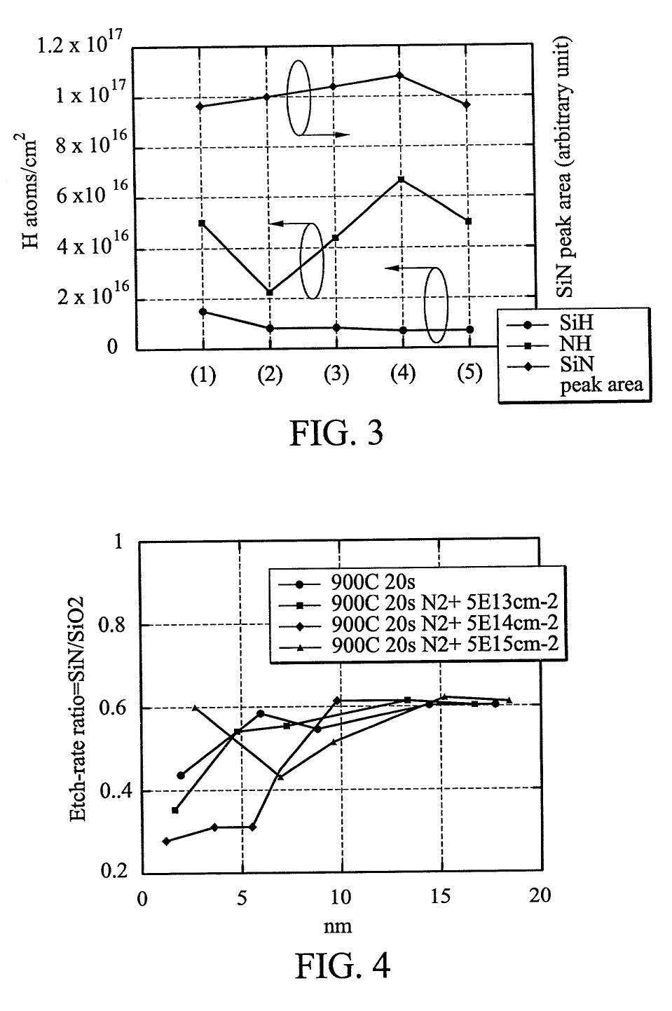

Next, following the ion implantation, a thermal annealing process 106 is carried out at about 600° to 950° C. for about 5 seconds to 30 minutes, and preferably at about 800° to 950° C. for about 5 seconds to 20 seconds. The thermal annealing 106 is applied to repair the dissociation of Si—H and N—H bonds or other implant damage. More importantly, the thermal annealing is applied to promotes Si—N and N—H bonding in the nitride layer 102a. The implanted nitrogen ions are bonded to the Si dangling bond and hydrogen during the thermal annealing, which was confirmed by FT-IR (Fourier-transform infrared) analysis. In FIG. 3, the results of FT-IR analysis show that the hydrogen concentration of NH bond as well as the Si—N peak area are increased by the combined nitrogen ion implantation and thermal annealing processes. This means a hardened silicon nitride is obtained.

Following this, as shown in FIG. 2C, an oxide layer 108 is deposited over the hardened silicon nitride layer by conventional means such as by chemical vapor deposition (CVD). In subsequent fabrication steps, a variety of semiconductor structures such as conductive plugs, cylindrical bottom electrodes, or the like can be fabricated on the substrate by conventional techniques including, for example, deposition, photolithography, etching, and chemical mechanical polishing. When the oxide layer 108 is no longer necessary, it can be stripped from substrate surface by wet etching using the hardened silicon nitride layer as an etch stop.

The hardened silicon nitride was checked for etch selectivity with respect to silicon oxide by 0.25% HF solution and the results are shown in FIG. 4. In FIG. 4, etch-rate ratio of SiN/SiO₂ is plotted on the ordinate axis, and etching depth is plotted on the abscissa. It is apparent from FIG. 4 that the HCD-based SiN treated by the combined nitrogen implantation and thermal annealing processes is more resistant to HF etch than the untreated one (whose etch-rate ratio is approximately 1). For silicon nitride implanted with a dose of 5×10¹⁴ cm⁻² N₂⁺, the etch-rate ratio can be kept below 0.5 until the etching reaches to 8 nm depth. However, note that in the case of over-implantation (5×10¹⁵ cm⁻²), the etch rate of silicon nitride was accelerated. This is because the excess nitrogen ions did not form SiN or NH bonds, but instead, made the film porous during the annealing process.

In view of the foregoing, it is readily appreciated that the present invention provides a useful method to reduce the etch rate of silicon nitride relative to that of silicon oxide. By this method, the HCD-based SiN can serve as an etch stop for silicon oxide, and therefore can be employed in the fabrication of (but not limited to) the next generation cylindrical DRAMs to favor the reduction in thermal budget.

While the invention has been particularly shown and described with reference to the preferred embodiment thereof, it will be understood by those skilled in the art that various changes in form and details may be made without departing from the spirit and scope of the invention.

What is claimed is:

1. A method of reducing the wet etch rate of a silicon nitride layer, comprising the steps of:
forming a silicon nitride layer on a semiconductor substrate;
implanting nitrogen-containing ions into the silicon nitride layer; and
thermally annealing the nitrogen-implanted silicon nitride layer to promote Si—N bonding in the layer.

2. The method as claimed in claim 1, wherein the silicon nitride layer is formed through a low pressure chemical vapor deposition process.

3. The method as claimed in claim 2, wherein the silicon nitride layer is deposited by reacting hexachlorodisilane (Si₂Cl₆) with ammonia (NH₃).

4. The method as claimed in claim 1, wherein the nitrogen-containing ions are N₂⁺ ions.

5. The method as claimed in claim 1, wherein the nitrogen-containing ions are implanted with a dose of about 10¹² to 10¹⁷ ions per cm².

6. The method as claimed in claim 5, wherein the nitrogen-containing ions are implanted with an energy level of about 0.5 to 20 keV.

7. The method as claimed in claim 1, wherein the silicon nitride layer is annealed at a temperature of about 600° to 950° C.

8. The method as claimed in claim 7, wherein the silicon nitride layer is annealed for about 5 seconds to 30 minutes.

9. A method of fabricating a semiconductor device, comprising the steps of:
forming a silicon nitride layer on a semiconductor substrate;
implanting nitrogen-containing ions into the silicon nitride layer;
thermally annealing the nitrogen-implanted silicon nitride layer to promote Si—N bonding in the layer;
forming an oxide layer over the silicon nitride layer; and
selectively removing the oxide layer by wet chemical etching using the silicon nitride layer as an etch stop.

10. The method as claimed in claim 9, wherein the silicon nitride layer is formed through a low pressure chemical vapor deposition process.

11. The method as claimed in claim 10, wherein the silicon nitride layer is deposited by reacting hexachlorodisilane (Si₂Cl₆) with ammonia (NH₃).

12. The method as claimed in claim 9, wherein the nitrogen-containing ions are N₂⁺ ions.

13. The method as claimed in claim 9, wherein the nitrogen-containing ions are implanted with a dose of about 10¹² to 10¹⁷ ions per cm².

14. The method as claimed in claim 13, wherein the nitrogen-containing ions are implanted with an energy level of about 0.5 to 20 keV.

15. The method as claimed in claim 9, wherein the silicon nitride layer is annealed at a temperature of about 600° to 950° C.

16. The method as claimed in claim 15, wherein the silicon nitride layer is annealed for about 5 seconds to 30 minutes.

17. The method as claimed in claim 9, wherein the oxide layer is selectively removed by a diluted HF solution.

18. A method for fabricating a cylindrical capacitor, comprising the steps of:
forming a silicon nitride layer on a semiconductor substrate by reacting hexachlorodisilane (Si₂Cl₆) with ammonia (NH₃) through a low pressure chemical vapor deposition process;
implanting nitrogen-containing ions into the silicon nitride layer with a dose of about 10¹² to 10¹⁷ ions per cm;
thermally annealing the silicon nitride layer at a temperature of about 600° to 950° C.;
forming an oxide layer over the silicon nitride layer; and
selectively removing the oxide layer using a diluted HF solution.

19. The method as claimed in claim 18, wherein the silicon nitride layer is deposited at a temperature below 650° C.

20. The method as claimed in claim 18, wherein the nitrogen-containing ions are N₂⁺ ions.

21. The method as claimed in claim 18, wherein the nitrogen-containing ions are implanted with an energy level of about 0.5 to 20 keV.

22. The method as claimed in claim 18, wherein the silicon nitride layer is annealed for about 5 seconds to 30 minutes.
